(19) United States
(12) Patent Application Publication
(10) Pub. No.: US 2012/0236354 A1
(43) Pub. Date: Sep. 20, 2012

(54) INFORMATION PROCESSING APPARATUS, INFORMATION PROCESSING METHOD, AND PROGRAM

(75) Inventor: Akihiro Mitsui, Kawasaki-shi (JP)

(73) Assignee: CANON KABUSHIKI KAISHA, Tokyo (JP)

(21) Appl. No.: 13/512,859

(22) PCT Filed: Dec. 2, 2010
(86) PCT No.: PCT/JP2010/072059

§ 371 Date: May 30, 2012

(30) Foreign Application Priority Data
Dec. 9, 2009 (JP) 2009-279713

(51) Int. Cl. G06F 3/12; G06K 15/02

(52) U.S. Cl. 358/1.13

(57) ABSTRACT

It is an object to provide such a technique that when an apparatus which provides a plurality of functions is connected to a PC or the like, if a connection destination is the same apparatus type, a link to all of the functions of the apparatus is enabled to be used on a device detailed page of a device stage. Device driver means has: list-up means for listing up registered device driver means which have already been registered in operating system means when the device driver means is installed; discriminating means for discriminating whether or not the registered device driver means of a port which coincides with a port of the device driver means exists among the registered device driver means listed up by the list-up means; and storing means for storing a type and a driver name of a driver of the registered device driver means into a storage device if it is determined by the discriminating means that the registered device driver means of the port which coincides with the port of the device driver means exists among the registered device driver means which were listed up by the list-up means.

### TECHNICAL FIELD

The invention relates to an information processing apparatus, an information processing method, and a program.

### BACKGROUND ART

In recent years, the number of devices which can be connected to a PC has increased. Hitherto, the devices which can be connected to the PC were input devices such as keyboard, mouse, and the like and output devices such as printer, display, and the like. However, not only external storage devices such as USB memory, SD card, and the like but also devices such as camera, microphone, cellular phone, and the like can be connected to the PC. Further, the devices can be connected to the PC through a wide area network such as LAN, WAN, or the like by a technique such as UPnP, WSD (Web Service On Devices), Bonjour, or the like.

In an environment where a number of devices have been connected as mentioned above, if a list of the devices connected to the PC is merely displayed on a tree, the user cannot easily know which device has actually been connected by which kind of method. Particularly, as for printers in an office environment, even if a plurality of printers were connected to the PC, all of them are displayed by the same icon. Therefore, the user cannot know which one of the icons indicates the printer selected as an output destination even if he merely saw the icon. Even if a plurality of USB memories were connected, the user cannot know which one of the USB memories has been allocated to which one of the drives.

To avoid such a problem that it is difficult to know the connecting form of the devices, various kinds of techniques were proposed in the past. For example, there is such a technique that the present state of the printer is transmitted to the PC and the icon is changed according to such a state, thereby enabling information showing an error such as absence of paper, absence of ink toner, or the like to be easily known (Japanese Patent Application Laid-Open No. H08-278868).

In Windows (registered trademark) 7, a new user interface called a device stage is added (“online”, Dec. 5, 2008, [viewed on Aug. 28, 2009], Internet <http://www.microsoft.com/japan/whdc/device/DeviceExp erience/MfpDevExp.mspx>). The device stage is constructed by: a gallery view of “device & printer” in which all devices connected to the PC are displayed as a list by icons; and a device detailed page for displaying a portal site specified to each device. In the gallery view of “device & printer”, since all of the devices connected to the PC are displayed by custom icons each having a shape and a color which are similar to those of each device, a visibility is high for the user. In the device stage, when the user clicks each icon, the portal site of the device detailed page is displayed. In the portal site, the custom icon, status information of the device, and a logo of the maker are displayed and a link to various kinds of device functions called tasks is displayed. Not only a link to an online manual and a purchase page of device options but also a link to functions of the devices, annexed applications, and utilities, such as print settings of the printer, fetching of a scanner image, and the like exist.

By such a technique, when a plurality of devices have been connected to the PC, the device can be specified without making the icons complicated and the user does not waver in his judgment when he uses the functions.

However, in the device stage of Windows 7, in the case of a multifunction apparatus having a plurality of functions per apparatus, there is a case where the device detailed page is formed every function. When the device is connected to the PC and is automatically recognized by the plug and play, even in the case of the multifunction apparatus having a plurality of functions, it is recognized as one device by an ID for grouping the functions of the device, and one device detailed page having a link to all of the functions of the multifunction apparatus is formed. However, when the device is connected to the PC, a connection destination is manually designated, and when a device driver is installed, there is a case where the device detailed page is formed every function. This is because the device detailed page is formed in association with the device driver. That is, if the device drivers of the scanner, printer, and FAX differ, the different device detailed pages are formed, respectively. Further, even in the printer function, if the drivers differ every PDL (page description language of the printer) in one device, a plurality of device detailed page are further formed. When such a state occurs, if the functions which are linked from the portal site of the device detailed page are associated with the scanner driver, only the scanner function is displayed, and if they are associated with the printer driver, only the printer function is displayed.

### SUMMARY OF INVENTION

### Technical Problem

It is an object of the invention to provide such a technique that when an apparatus which provides a plurality of functions is connected to a PC or the like, if a connection destination is a same apparatus type, a link to all of the functions of the apparatus is enabled to be used on a device detailed page of a device stage.

### Solution to Problem

In order to solve the problems discussed above, the information processing apparatus of the present invention has device driver means and operating system means, wherein the device driver means comprises: list-up means for listing up the registered device driver means which have already been registered in the operating system means when the device driver means is installed; discriminating means for discriminating whether or not the registered device driver means of a port which coincides with a port of the device driver means exists among the registered device driver means which were listed up by the list-up means; and storing means for storing a type and a driver name of a driver of the registered device driver means into a storage device if it is determined by the discriminating means that the registered device driver means of the port which coincides with the port of the device driver means exists among the registered device driver means listed up by the list-up means, and wherein the operating system means comprises: task list-up means for listing up a list of tasks to be displayed on a device detailed page activated from a custom object which shows a device of the device driver means associated with a device stage, each of the tasks showing a link to functions that are provided by the device shown by the custom object; and display means for displaying the tasks showing the link to the functions that are provided by the device shown by the custom object on the device detailed page in the case where the device of a type that coincides with a type of driver stored in the storage device by the storing means exists among the devices regarding the tasks listed up by the task list-up means.

### Advantageous Effects of Invention

According to the invention, such a technique that when the apparatus which provides a plurality of functions is connected to the PC or the like, if the connection destination is the same apparatus type, the link to all of the functions of the apparatus is enabled to be used on the device detailed page of the device stage can be provided.

Further features of the present invention will become apparent from the following description of exemplary embodiments with reference to the attached drawings.

### BRIEF DESCRIPTION OF DRAWINGS

FIG. 1 is a diagram illustrating an example of a system construction using a computer as an example of a client.

FIG. 2 is a diagram schematically illustrating an example of an environment of a network.

FIG. 3 is a diagram illustrating an example of a user interface of a device stage.

FIG. 4 is a diagram illustrating an example of a user interface of a device stage.

FIG. 5 is a diagram illustrating an example of PackageInfo.xml.

FIG. 6 is a diagram illustrating an example of DeviceInfo.xml.

FIG. 7 is a diagram illustrating an example of WindowsInfo.xml.

FIG. 8 is a diagram illustrating an example of Behavior.xml.

FIG. 9 is a diagram illustrating an example of Tasks.xml.

FIG. 10 is a diagram for describing an installation of a device driver.

FIG. 11 is a flowchart illustrating an example of an installing process of the device driver according to an embodiment 1.

FIG. 12 is a diagram illustrating an example of a construction of set values in a registry.

FIG. 13 is a flowchart illustrating an example of a process for displaying tasks to the device stage.

FIG. 14 is a diagram illustrating one task written in Tasks.xml.

FIG. 15 is a flowchart illustrating an example of an uninstalling process of the device driver according to the embodiment 1.

FIG. 16 is a flowchart illustrating an example of an installing process of a device driver according to an embodiment 2.

FIG. 17 is a flowchart illustrating an example of an uninstalling process of the device driver according to the embodiment 2.

### DESCRIPTION OF EMBODIMENTS

An embodiment of the invention will be described hereinbelow with reference to the drawings.

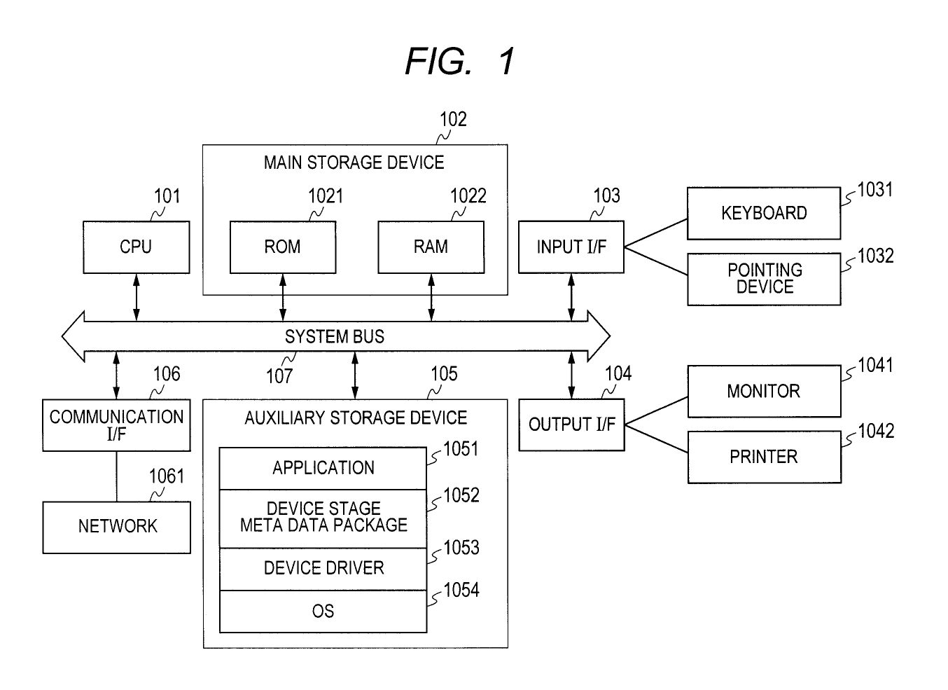

FIG. 1 is a diagram illustrating an example of a system construction using a computer as an example of a client (information processing apparatus). The invention may be embodied by a sole apparatus, a system constructed by a plurality of apparatuses, or a system which is connected through a network and in which processes are executed so long as functions of the embodiment are executed unless otherwise specified.

A CPU 101 controls the whole apparatus in accordance with a program stored in a ROM 1021 or a RAM 1022 in a main storage device 102 or stored in an auxiliary storage device 105. The RAM 1022 is also used as a work area when the CPU 101 executes various kinds of processes. The auxiliary storage device 105 records an operating system (OS) 1054, application software 1051, and the like. Input devices such as keyboard 1031 and pointing device 1032 represented by a mouse, a touch panel, or the like are devices which are used by the user to issue various kinds of instructions to the computer through an input I/F 103. An output I/F 104 is an interface for outputting data to the outside. The output I/F 104 outputs the data to an output device such as monitor 1041, printer 1042, or the like. The computer may be directly connected to the printer 1042 through a local I/O, or indirectly to the printer 1042 via a network 1061 which is connected through a communication I/F 106. A common data system 107 is used to transmit and receive the data among the component elements of the computer mentioned above.

The CPU 101 executes the processes based on the program, so that functions of the clients, which will be described hereinafter, and processes according to flowcharts which are executed by the clients are realized.

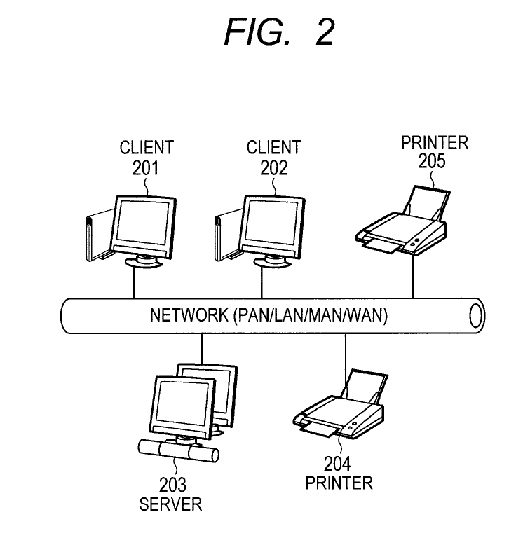

FIG. 2 is a diagram schematically illustrating an example of an environment of the network 1061. One or a plurality of clients 201/202 for forming a document or an image to be printed has/have been connected to the network. There is also a case where a server computer 203 for managing the printer has been connected to the network 1061. One or a plurality of printers 204/205 are connected to the network and there is also a case where even if the printer has physically been connected like a printer 205, the printer is in an offline state where it cannot actually be used. As a network, there are networks in a range from the network of a small scale to the network of a large scale like a PAN, a LAN, a MAN, a WAN, and the like and those devices are connected to all networks. Like a cloud or the like, the server and printer may be connected over the Internet. PAN is an abbreviation of Personal Area Network. LAN is an abbreviation of Local Area Network. MAN is an abbreviation of Metropolitan Area Network. WAN is an abbreviation of Wide Area Network.

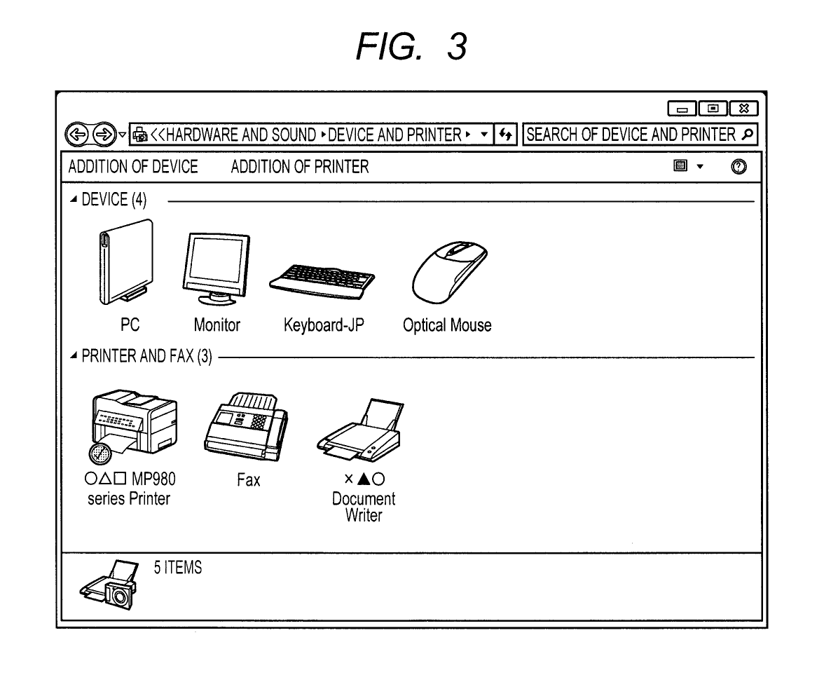

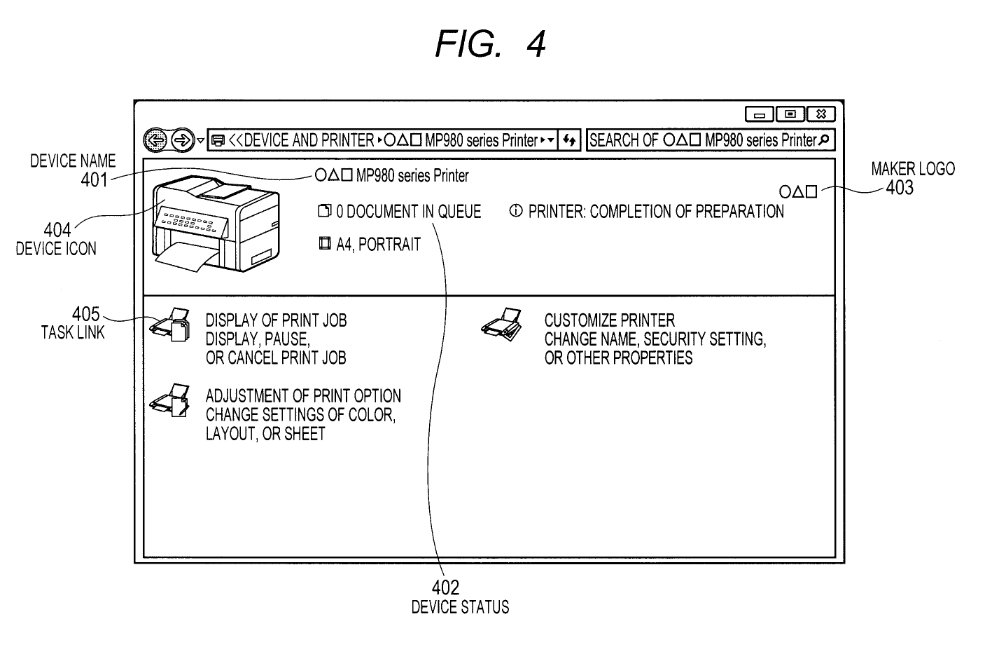

FIGS. 3 and 4 are diagrams each illustrating an example of a user interface of a device stage. The user interface (display screen) illustrated in FIG. 3 is a gallery view of “device & printer” in which all devices connected to the client are displayed as a list. Each device is shown by a large custom icon having a shape and a color similar to those of the device. Such an icon visually appeals to the user, thereby enabling the user to more easily understand the connected devices. The custom icon is an example of a custom object.

When the device has been connected to the client and a device driver 1053 has been installed, an icon is displayed. The device driver 1053 is a module necessary to control the device from the client. In the OS 1054, a default icon has been prepared every device type.

If a device stage meta data package 1052 has been associated with the device driver 1053, when the device driver 1053 is installed, the device stage is installed to the client. The custom icon similar to a shape of each device can be displayed. In the device stage, meta data such as XML describing the operation of the portal site and the like and resources such as icon, bitmap, and the like have been packaged into one compression file. Such a package is called a device stage meta data package 1052. The device stage and the device stage meta data package 1052 are also held in the auxiliary storage device 105 in a manner similar to the device driver 1053.

When installing the device driver 1053 necessary to make the device operative, the device stage meta data package 1052 is installed in association with a plug & play ID. Therefore, one device driver 1053 is certainly associated with one device stage meta data package 1052.

A user interface (display screen) illustrated in FIG. 4 is a portal site of the device detailed page which is activated from the icon of the “device & printer” gallery view. The portal site is mainly classified into the following two areas: a branding bar area for displaying a device name 401, a device status 402 which displays a device status, a logo 403 of the maker, and a custom icon 404 of the device; and an area of a link 405 to a task. The task is a device function which is linked from the portal site. A link to an online manual and a purchase page of device options is a main link. However, links to the functions of the device, annexed applications, and utilities such as print settings of the printer, fetching of a scanner image, and the like can be also described as tasks. In the printer, only the tasks regarding the printing exist. However, in the multifunction apparatus, not only the task regarding the printing but also tasks regarding the FAX and scanner are simultaneously displayed in the portal site.

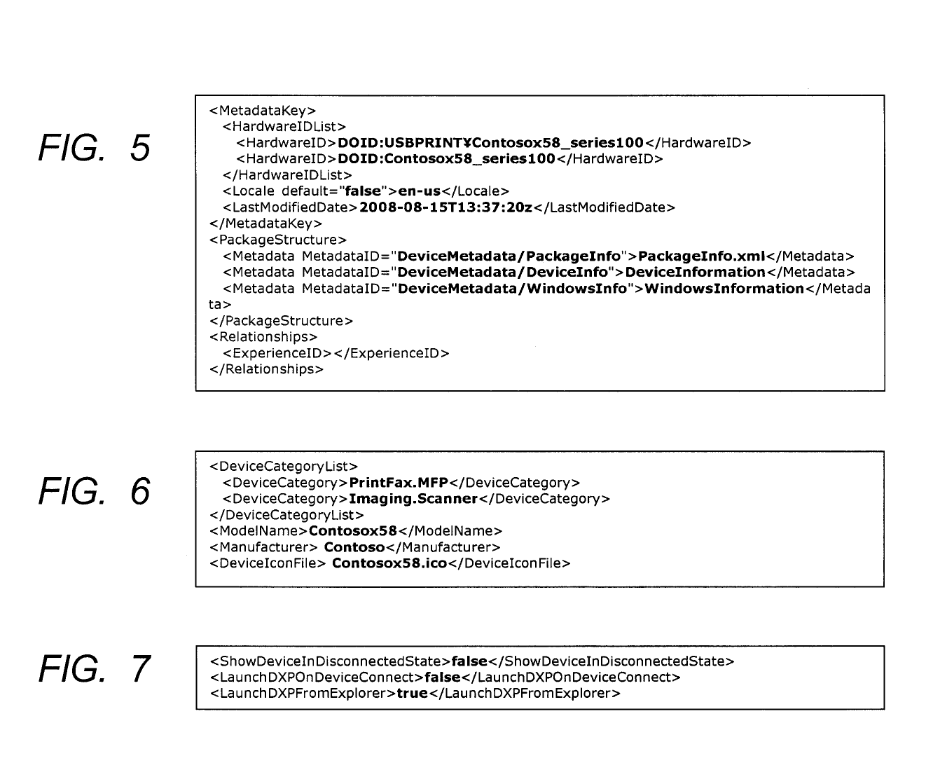

FIGS. 5, 6, 7, 8, and 9 are diagrams each illustrating an example of an XML file for constructing a device stage which is included in the device stage meta data package 1052. PackageInfo.xml shown in FIG. 5 illustrates the XML file which manages the whole device stage and describes how the device stage meta data package is constructed. More specifically speaking, a hardware ID, locale information, and the like for associating with the device driver 1053 have been written in PackageInfo.xml. The OS 1054 constructs the display screen of the device stage from the data included in the package on the basis of the information in PackageInfo.xml.

Information of a target device has been written in DeviceInfo.xml. More specifically describing, a category showing the device type and a model name, a maker name, and the like of the device have been written in DeviceInfo.xml. In the case of the multifunction apparatus, three kinds of categories regarding the printer, FAX, and scanner have been written in DeviceInfo.xml.

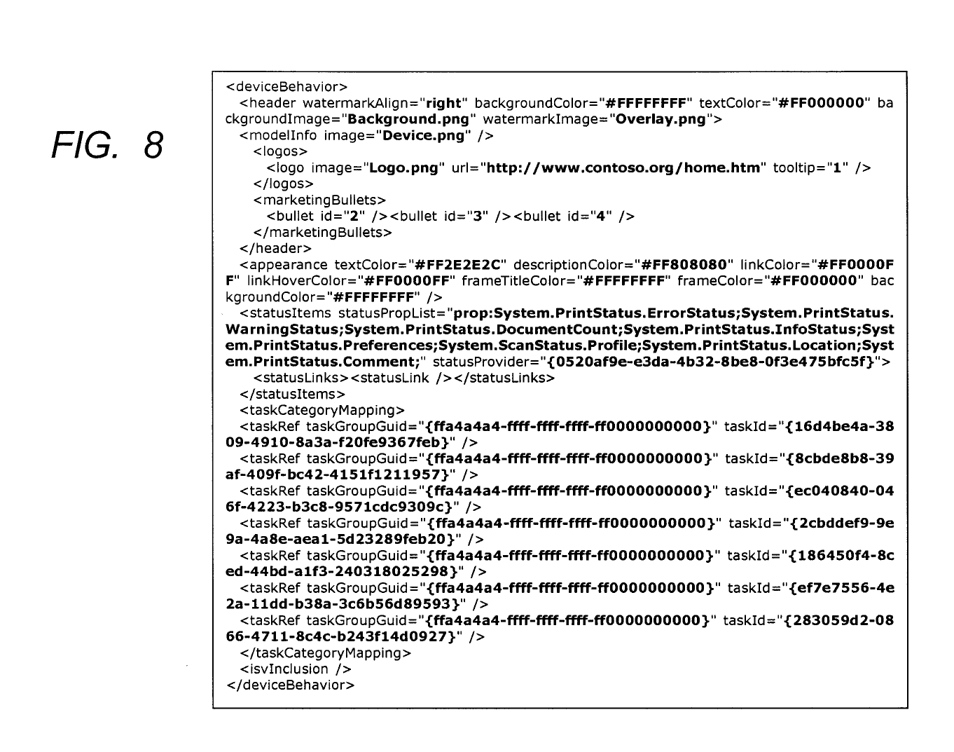

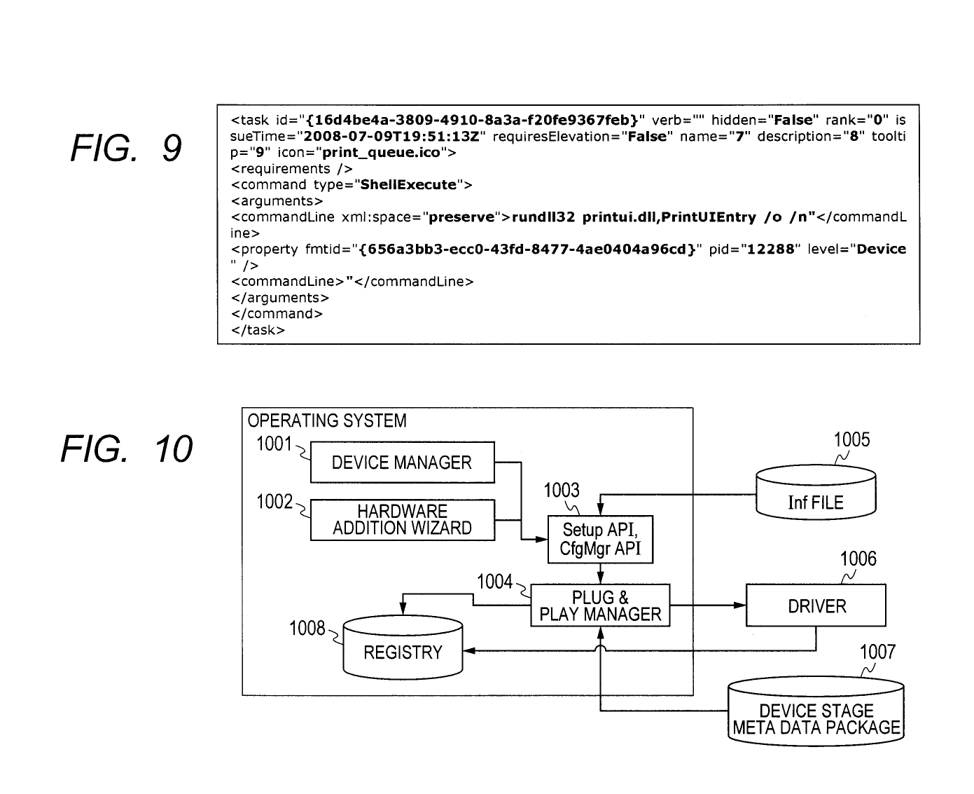

WindowsInfo.xml in FIG. 7 is a file for notifying the OS 1054 of a construction of the device stage. FIGS. 8 and 9 are files in each of which information for constructing the portal site of the device detailed page of the device stage has been written. How a layout of the branding bar of the device detailed page is constructed has been written in Behavior.xml in FIG. 8. More specifically describing, what is displayed as a device status 402, icon file names such as logo 403 of the maker, custom icon 404 of the device, and the like, information showing that the link 405 of which task type exists, and the like have been written in Behavior.xml. The OS 1054 displays an icon file in the package by designating the file name included in the device stage meta data package. Tasks.xml in FIG. 9 is a file in which what kind of operation is executed when the link 405 of the task is clicked has been written. More specifically describing, a designation of a program which is activated, a URL of a link destination, and the like have been written in Tasks.xml.

Those five kinds of XML files and the resource data such as icon file, bitmap, and the like are compressed and combined into one file, thereby forming the device stage meta data package 1052.

FIG. 10 is a diagram for describing an installation of the device driver. A module included in the OS 1054 installs the device driver which is provided every device. First, a device manager 1001 for displaying a list of the devices connected to the PC and a hardware addition wizard 1002 start the installing process of the device driver 1053. Particularly, when the printer driver is installed, an addition wizard of the dedicated printer serving as a printer edition of the hardware addition wizard 1002 executes the process. The hardware addition wizard 1002 is simply referred to as an addition wizard 1002 hereinbelow.

Upon installation, first, the addition wizard 1002 displays a user interface of an interactive format. Subsequently, the addition wizard 1002 allows the user to select an inf file (Device Setup Information File) 1005, a driver type, an apparatus type name of the device, and a port name of a connection destination through the user interface. The addition wizard 1002 forms install setup information based on the selected information.

The inf file 1005 is a file in which an installing method of the device driver has been written. The apparatus type name, the plug & play ID, the module construction, and the like have been written. When the install setup information is formed, the addition wizard 1002 calls a Setup API and CfgMgr API 1003 serving as an API of the OS 1054, thereby starting the installing process. The API is an abbreviation of Application Programming Interface.

The Setup API and CfgMgr API 1003 obtains the inf file 1005 of the device driver based on the install setup information. The Setup API and CfgMgr API 1003 sends the inf file 1005 to a plug and play manager 1004. The plug & play manager 1004 actually installs the device driver 1053. The plug & play manager 1004 obtains the plug & play ID from the inf file 1005 based on the apparatus type name of the device of the install setup information.

The method of installing the device driver 1053 in accordance with the user interface of the interactive format is called a manual installation.

As another method, there is a plug & play whereby the device is connected to the PC and the installation of the device driver 1053 is automatically started. In the case of the plug & play, the plug & play manager 1004 searches for the apparatus type name from the plug & play ID on the contrary to the manual installation. When the device is connected, the plug & play manager 1004 receives a character train of MFG showing a company name and a character train of MDL showing a device name and forms a plug & play ID. Based on the formed plug & play ID, the plug & play manager 1004 searches for the apparatus type name of the same plug & play ID written in the inf file 1005. The above operation is the installation of the device driver 1053 by the plug & play.

If the apparatus type name and the plug & play ID could be decided by using the inf file 1005 by one of the above methods, the plug & play manager 1004 reads out the related module construction and installs the related module from the package of a driver 1006. At this time, the plug & play manager 1004 writes the apparatus type name and the plug & play ID into a registry 1008.

The registry 1008 is a database to store set values of the OS 1054. The set values are stored by a set of three values of the name, type, and data. The OS 1054 itself can also write and read out the set values into/from the registry 1008 through the OS 1054 from the device driver 1053.

By the installing operation of the device driver 1053 which is executed by the OS 1054, one device driver 1053 per apparatus type is installed. Even if the plug & play operation which is started by connecting the PC to the device is not executed, the plug & play ID is obtained from the inf file 1005 and can be also associated with the apparatus type name.

When the installation of the device driver 1053 is finished, the plug & play manager 1004 subsequently installs the device stage. The plug & play manager 1004 executes the installing operation by using a device stage meta data package 1007 held in a DeviceMetadataStore folder of the OS 1054 as installation data of the device stage. The device stage meta data package 1007 which the OS 1054 possesses has already existed in the DeviceMetadataStore folder. However, the device stage meta data package 1007 peculiar to the device can be also additionally installed. There are the following two adding methods.

One is a method whereby the device stage meta data package 1007 is copied into the DeviceMetadataStore folder by using an installer or by downloading from a site of the Internet. The other is a method whereby the device stage meta data package is written as one of the constructing files into the inf file 1005 and when the plug & play manager 1004 installs the device stage, the package is copied. Even by using any one of those methods, when the device stage meta data package is copied into the DeviceMetadataStore folder, the OS 1054 decompresses the compressed package and sets the file as contents of the package into the DeviceMetadataStore folder. This file is called device stage meta data cache. When installing the device stage, the plug & play manager 1004 obtains a PackageInfo.xml file by seeing the device stage meta data cache of the DeviceMetadataStore folder. The plug & play manager 1004 obtains a model name written in the PackageInfo.xml file, discriminates whether or not it coincides with the apparatus type name of the device driver which has been installed at present, and installs the device stage in which they coincide. If there are no device stages in which they coincide, the device stage is not installed but a default icon which the OS 1054 has is merely displayed.

### Embodiment 1

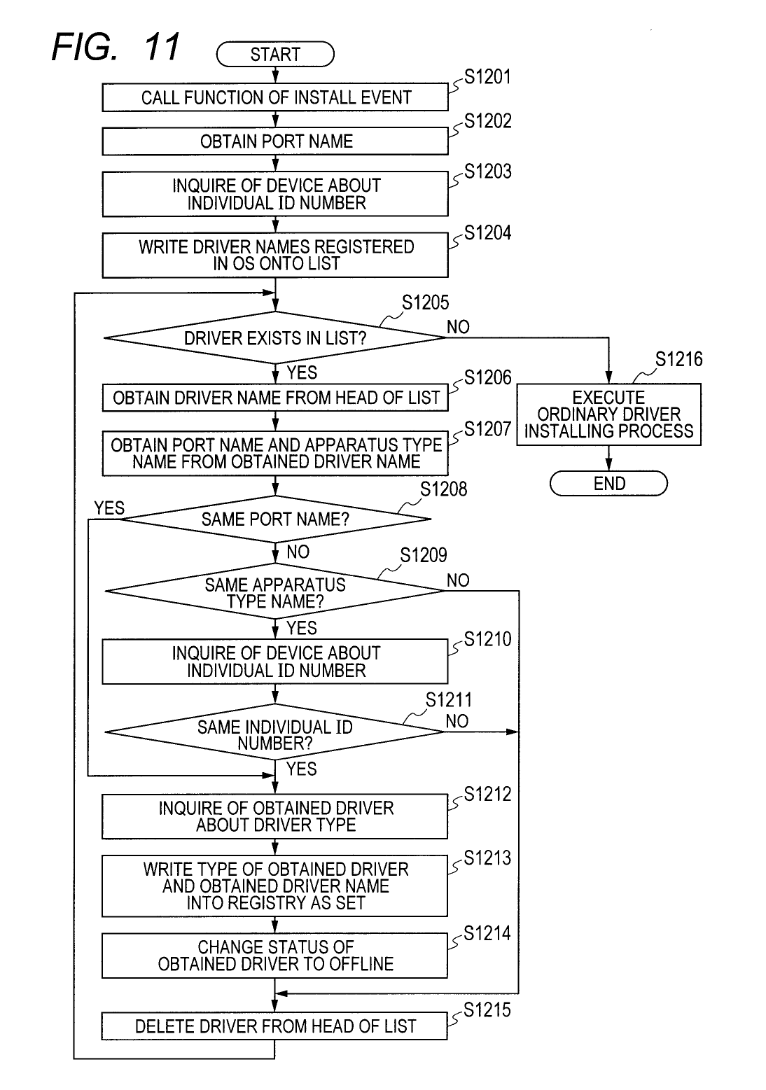

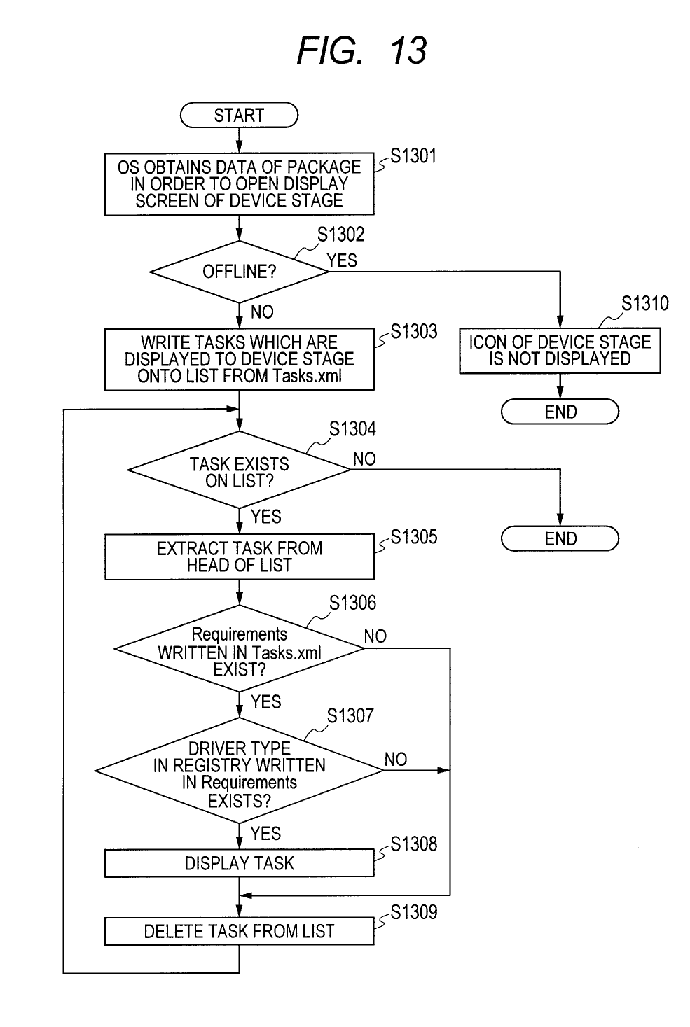

Subsequently, an embodiment 1 will be described by using flowcharts of FIGS. 11 and 13. FIG. 11 is a flowchart illustrating an example of the installing process of the device driver 1053.

When installing the device driver 1053, first, the OS 1054 calls an install event function of the device driver 1053 (S1201). Then, the device driver 1053 calls the API of the OS 1054 and obtains a name of a port which is connected to the device (S1202). Subsequently, the device driver 1053 obtains an individual identification number (serial number) from the connected device (S1203). It is obtained by a method whereby a command is sent to the device and a response from the device is received.

Subsequently, the device driver 1053 extracts device drivers of the same type which have already been registered in the OS 1054 and stores them as a list (S1204). The driver type is a category such as printer if the device driver to be installed at present is a printer driver, scanner if it is a scanner driver, FAX if it is a FAX driver, or the like. Subsequently, the device driver 1053 may extract device drivers (registered device drivers) which have already been registered in the OS 1054 and store them as a list.

The device driver 1053 discriminates whether or not the drivers exist on the list, that is, whether or not the device driver of the same type exists among the device drivers which have already been installed (S1205). The device driver 1053 obtains the names of the device drivers in order from the head of the list (S1206). The device driver 1053 obtains the name of the port connected to the device and the apparatus type name from the obtained device driver names (S1207). The device driver 1053 discriminates whether or not the port name is the same as that of the device driver to be installed at present (S1208) and discriminates whether or not the apparatus type name is the same as that of the device driver (S1209). The device driver 1053 inquires of the device of the device driver whose driver name has been obtained about the individual identification number (S1210). The device driver 1053 confirms that the individual identification number also coincides (S1211). The process of S1211 is an example of a coincidence discriminating process. The device driver 1053 inquires about the type from the obtained device driver (S1212). The device driver 1053 stores the type and name of the obtained device driver as a set into the registry 1008 (S1213).

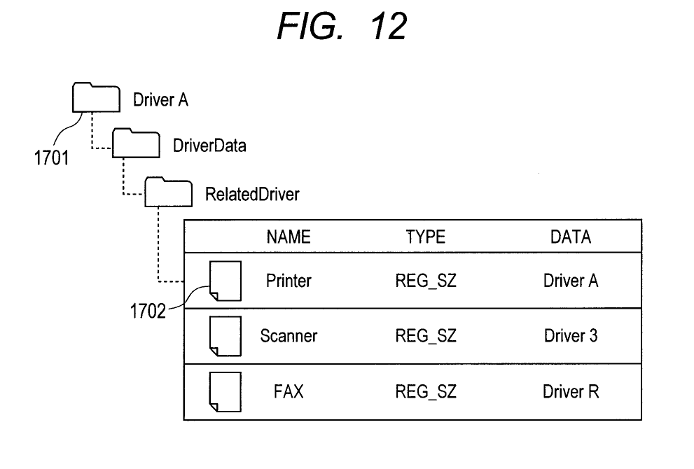

FIG. 12 is a diagram illustrating an example of a construction of the set values stored in the registry 1008. The registry 1008 is constructed by registry data 1702 and a registry folder 1701 which collects the data. The device driver 1053 stores the data of the related driver into a device driver in the registry folder 1701. As registry data 1702, three kinds of elements of the name, type, and data are stored as one set. The device driver 1053 stores each set constructed by the type of device driver 1053 obtained as a name, REG_SZ showing that the data is a character train obtained as a type, and the name of device driver obtained as data.

The device driver 1053 changes a status of the obtained device driver to offline by using the API of the OS 1054 (S1214). The device driver 1053 deletes the process-completed device drivers from the list in order to see the next device drivers written on the list (S1215) and executes similar processes to all of the same type of device drivers. After completion of the processes, the device driver 1053 starts the ordinary installing process (S1216) and completes the installation of the device drivers.

After the installation of the device drivers was completed and when the installation of the device stage is finished, a flowchart illustrating an example of a process for displaying tasks to the device stage in FIG. 13 is started. When the user opens the “device & printer” gallery view, the OS 1054 obtains the file of the device stage meta data package in order to display the custom icon of the device stage (S1301). The OS 1054 refers to the status of the device driver 1053 associated with the device stage and discriminates whether or not it is offline (S1302). If a plurality of device drivers associated with the device stage exist, the OS 1054 executes the process of 51302 the number of times as many as the number of device drivers associated with the device stage.

If the status is offline as a result of the discrimination in S1302, the OS 1054 sets the custom icon of the device stage into a non-display mode so that it is not displayed in the “device & printer” gallery view (S1310). In the case of displaying the icon, the OS 1054 obtains information to display the portal site of the device detailed page from Behavior.xml and Tasks.xml. At this time, the OS 1054 holds the links (tasks) to the tasks as a list (S1303). That is, the OS 1054 lists up the lists of the tasks. The process of S1303 is an example of the processes for listing up the tasks.

In the discrimination in S1302, the OS 1054 may discriminate whether or not the status is offline and whether or not ShowDeviceInDisconnectedState of WindowsInfo.xml of the device stage is false. If it is offline and ShowDeviceInDisconnectedState of WindowsInfo.xml of the device stage is false, the OS 1054 may advance to S1310.

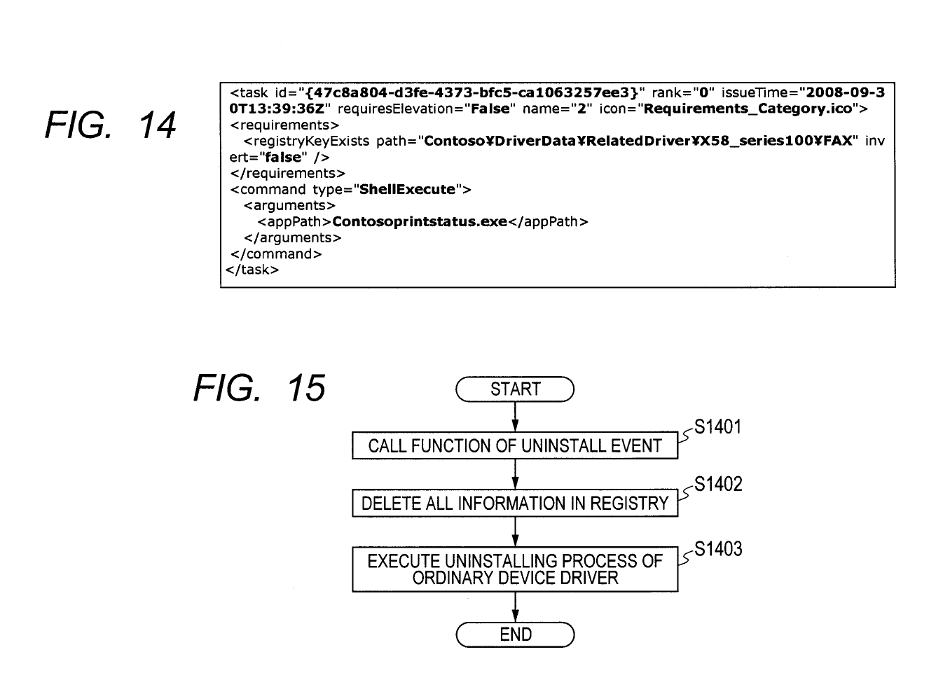

FIG. 14 is a diagram illustrating one task written in Tasks.xml. Although the OS 1054 constructs a display screen of the portal site of the device detailed page, it processes only the task by using the list. The OS 1054 extracts the task from the list (S1305). When there is a Requirements element in the task (S1306), the OS 1054 searches the written registry 1008. In the Requirements element, the registry 1008 stored in S1213 of the flowchart of FIG. 11, that is, the position of FIG. 12 written by the device driver 1053 during the installation has been written. Thus, the OS 1054 can read out the driver types from the registry 1008 stored by the device driver 1053. If the same driver type as that written in the Requirements element exists among the read-out types (S1307), the OS 1054 displays the task to the device detailed page (S1308) and deletes it from the list (S1309). If the processes of all tasks on the list were finished by repeating the above processes (S1304), the display of the device detailed page is completed. By those processes, the device driver 1053 constructs a display screen of the device stage based on the registry 1008 which has previously been formed by the device driver 1053. Therefore, the functions of the multifunction apparatus associated with the same port are displayed according to the device driver 1053 irrespective of the plug & play.

When the user designates the icon of the “device & printer” gallery view and deletes the device driver 1053, the device driver 1053 operates according to a flowchart of FIG. 15. First, the OS 1054 calls a function of an uninstall event of the device driver 1053 (S1401). Subsequently, the device driver 1053 deletes all of the written registries 1008 (S1402). The ordinary uninstalling process is executed (S1403) and the device driver 1053 is deleted. Since the registries 1008 were deleted, when the device stage is subsequently displayed, the task of the related function is deleted and cannot be used. In this manner, a relationship between the device driver 1053 and the task is held even after the deletion.

The processes of the embodiment can be applied not only to the printer driver but also to all of the device drivers 1053 such as scanner driver, FAX driver, and the like. In the case where the device can be discriminated merely by the port name, it is not always necessary to inquire of the device about the individual identification number. When an IP address is allocated every function like IPV6 or the like, since the same port name does not exist, the device driver 1053 specifies the device by using the individual identification number.

### Embodiment 2

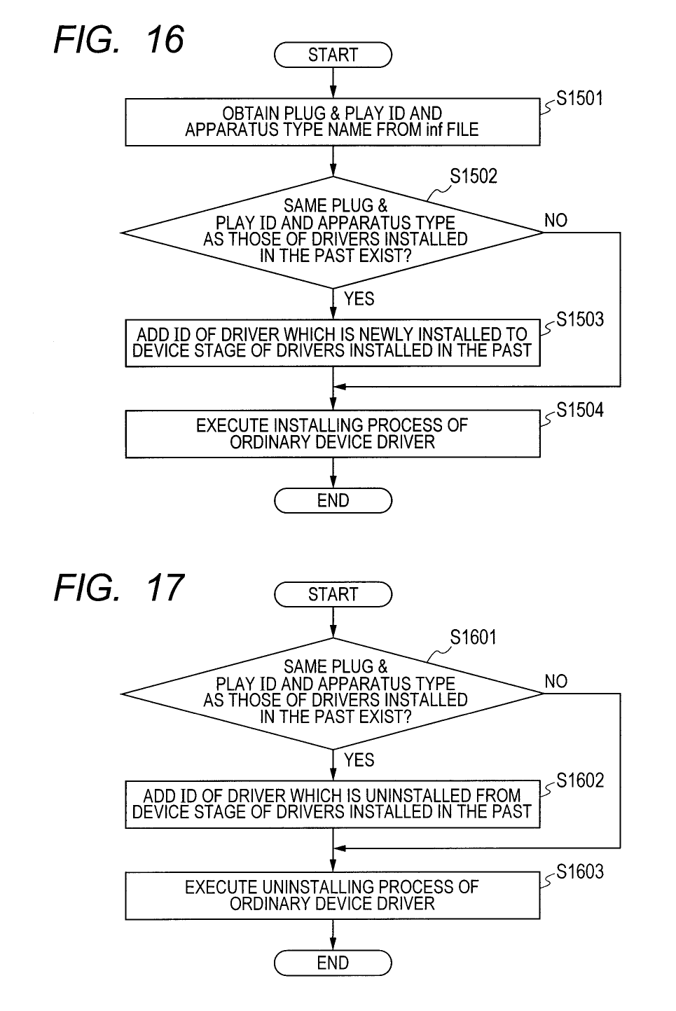

A process in which the OS 1054 searches for the device driver of the same port will now be described as an embodiment 2. In the embodiment 1, the process in which the device driver 1053 searches for the device driver of the same port and transfers the information to the device stage through the registry 1008 has been described. In the embodiment 2, an example in which the OS 1054 executes such a process will be described. As shown in Tasks.xml in FIG. 9, by using a Property element, each task can refer to the installation information of the device driver which the OS 1054 has and which is associated with the device stage. The OS 1054 manages the list of the associated device drivers together with a GUID. GUID is an abbreviation of Globally Unique Identifier. At the same time, the plug & play ID and the apparatus type name have been written on the list. By writing GUID into the Property element, for example, the OS 1054 can switch the display of the task by the associated device driver. However, since there is only one associated device driver in the manual installation, the OS 1054 searches for the device driver associated with another device stage and adds it. FIG. 16 is a flowchart illustrating an example of such a process.

When installing the device driver 1053, first, the OS 1054 obtains the plug & play ID and the apparatus type name from the inf file 1005 (S1501). The OS 1054 searches for all device stages. The OS 1054 discriminates whether or not the same plug & play ID and apparatus type name as those of the device driver 1053 serving as a target of the installation at present exist on the list of the device drivers and GUID which were installed in the past (S1502). That is, the OS 1054 lists up the device drivers and GUID, as a list, which were installed in the past and discriminates whether or not the same plug & play ID and apparatus type name as those of the device driver 1053 serving as a target of the installation at present exist on the list.

If the same plug & play ID and apparatus type name exist, the OS 1054 adds the device driver 1053 serving as a target of the installation at present as GUID of the device driver associated with the device stages which were installed in the past (S1504). GUID of the device driver is an example of identification information of the device driver. The process of 51504 is an example of the associating process.

The OS 1054 displays the custom icons which show the devices associated with the device stage onto the device stage. This process is an example of the custom object displaying process.

The OS 1054 displays the tasks which show a link to the functions provided by the device shown by the custom icons on the device detailed page activated from the custom icons. This process is an example of the task displaying process.

When the device driver is uninstalled, the OS 1054 executes processes according to a flowchart of FIG. 17. The OS 1054 searches for all of the device stages and discriminates whether or not the same plug & play ID and apparatus type name as those of the device driver 1053 which is uninstalled at present exist on the list of the device drivers and GUID which were installed in the past (S1601). If the device driver of the same plug & play ID and apparatus type name exists, the OS 1054 deletes the device driver which is uninstalled from GUID of the device drivers associated with the device stages which were installed in the past (S1602).

The OS 1054 searches for them as mentioned above, so that the device driver 1053 can switch the display of the icon and task of the device stage according to the function without executing any special process at the time of installing or uninstalling.

### Other Embodiments

The invention is also realized by executing the following processes. That is, software (program) for realizing the functions of the embodiments mentioned above is supplied to a system or an apparatus through a network or various kinds of storage media, and a computer (or a CPU, an MPU, or the like) of the system or apparatus reads out the program and executes processes based on the read-out program.

### INDUSTRIAL APPLICABILITY

According to the embodiments mentioned above, such a technique that when an apparatus which provides a plurality of functions is connected to the PC or the like, if the connection destination is the same apparatus type, the link to all functions of the apparatus is enabled to be used on the device detailed page of the device stage can be provided.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-279713, filed Dec. 9, 2009, which is hereby incorporated by reference herein in its entirety.

1. An information processing apparatus having a device driver unit and an operating system unit,
wherein the device driver unit comprises:
a list-up unit configured to list up at least one registered device driver unit which has been registered in the operating system unit when the device driver unit is installed;
a discriminating unit configured to discriminate whether or not a registered device driver unit of a port which coincides with a port of the device driver unit exists among the at least one registered device driver unit listed up by the list-up unit; and
a storing unit configured to store a driver type and a driver name of the registered device driver unit into a storage device if it is determined by the discriminating unit that the registered device driver unit of the port which coincides with the port of the device driver unit exists among the at least one registered device driver unit listed up by the list-up unit, and
wherein the operating system unit comprises:
a task list-up unit configured to list up tasks to be displayed on a device detailed page activated from a custom object which shows a device of the device driver unit associated with a device stage, each of the tasks showing a link to functions that are provided by the device shown by the custom object; and
a display unit configured to display the tasks showing the link to the functions that are provided by the device shown by the custom object on the device detailed page in the case where a device of a type that coincides with the driver type stored in the storage device by the storing unit exists among the devices regarding the tasks listed up by the task list-up unit.

2. The information processing apparatus according to claim 1,
wherein the device driver unit further comprises a changing unit configured to change a status of the device driver unit whose driver type and driver name have been stored in the storage device by the storing unit to offline,
wherein the operating system unit further comprises a non-display for unit configured to, when the device stage is displayed, set the custom object showing the device of the device driver unit into a non-display mode in the case where the status of the device driver unit associated with the device stage is offline, and
wherein the task list-up unit lists up the tasks in the case where the status of the device driver unit associated with the device stage is not offline.

3. The information processing apparatus according to claim 1, wherein the device driver unit further comprises a deleting unit configured to, when the device driver unit is uninstalled, delete the driver type and the driver name stored in the storage device by the storing unit from the storage device.

4. The information processing apparatus according to claim 1, further comprising a coincidence determining unit configured to, if it is determined by the discriminating unit that the registered device driver unit of the port which coincides with the port of the device driver unit does not exist among the at least one registered device driver unit listed up by the list-up unit, obtain an individual identification number from the device of an apparatus type name which coincides with that of the device of the device driver unit among the at least one registered device driver unit listed up by the list-up unit and discriminate whether or not the obtained individual identification number coincides with the individual identification number of the device of the device driver unit,
wherein if it is determined by the coincidence determining unit that the obtained individual identification number coincides with the individual identification number of the device of the device driver unit, the storing unit stores the driver type and the driver name of the registered device driver unit of the device whose individual identification number coincides with that of the device of the device driver unit into the storage device.

5. An information processing apparatus having an operating system unit,
wherein the operating system unit comprises:
a list-up unit configured to list up at least one registered device driver unit which has been registered in the operating system unit when the device driver unit is installed;
a discriminating unit configured to discriminate whether or not a registered device driver unit of a device type name and a plug and play ID which coincide with a device type name and a plug and play ID of the device driver unit exists among the at least one registered device driver unit listed up by the list-up unit; and
an associating for unit configured to, if it is discriminated by the discriminating unit that the registered device driver unit of the device type name and the plug and play ID which coincide with the device type name and the plug and play ID of the device driver unit exists among the at least one registered device driver unit listed up by the list-up unit, further associate identification information of the device driver unit with a registered device stage associated with the registered device driver unit.

6. The information processing apparatus according to claim 5, wherein the operating system unit further comprises:
a custom object display unit configured to display a custom object which shows the device associated with the device stage onto the device stage; and
a task display unit configured to display tasks each of which shows a link to functions that are provided by the device shown by the custom object onto the device detailed page activated from the custom object.

7. The information processing apparatus according to claim 5, wherein the operating system unit further comprises a deleting unit configured to, when the device driver unit is uninstalled, delete the identification information of the device driver unit associated with the registered device stage by the associating unit.

8. An information processing method carried out in an information processing apparatus having a device driver unit and an operating system unit, comprising:
by the device driver unit, listing up the at least one registered device driver unit which has been registered in the operating system unit when the device driver unit is installed;
by the device driver unit, discriminating whether or not a registered device driver unit of a port which coincides with a port of the device driver unit exists among the at least one registered device driver unit listed up in the list-up step;
by the device driver unit, storing a driver type and a driver name of the registered device driver unit into a storage device if it is determined in the discriminating step that the registered device driver unit of the port which coincides with the port of the device driver unit exists among the at least one registered device driver unit listed up in the list-up step;
by the operating system unit, listing up tasks to be displayed on a device detailed page activated from a custom object which shows a device of the device driver unit associated with a device stage, each of the tasks showing a link to functions that are provided by the device shown by the custom object; and
by the operating system unit, displaying the tasks showing the link to the functions that are provided by the device shown by the custom object on the device detailed page in the case where a device of a type that coincides with the driver type stored in the storage device in the storing step exists among the devices regarding the tasks listed up in the task list-up step.

9. An information processing method carried out in an information processing apparatus having an operating system unit,
by the operating system unit, listing up at least one registered device driver unit which has been registered in the operating system unit when the device driver unit is installed;
by the operating system unit, discriminating whether or not a registered device driver unit of a device type name and a plug and play ID which coincide with a device type name and a plug and play ID of the device driver unit exists among the at least one registered device driver unit listed up in the list-up step; and
by the operating system unit, if it is discriminated in the discriminating step that the registered device driver unit of the device type name and the plug and play ID which coincide with the device type name and the plug and play ID of the device driver unit exists among the at least one registered device driver unit listed up in the list-up step, further associating identification information of the device driver unit with a registered device stage associated with the registered device driver unit.

10. A non-transitory computer-readable storage medium storing a computer program for causing a computer to execute the information processing method according to claim 9.

11. A non-transitory computer-readable storage medium storing a computer program for causing a computer to execute the information processing method according to claim 9.
